(19) United States
(12) Patent Application Publication
(10) Pub. No.: US 2026/0352260 A1
(43) Pub. Date: Nov. 5, 2026

(54) SYSTEMS AND METHODS FOR PROVIDING PORTABLE DC-POWERED TELECOMMUNICATIONS

(71) Applicant: Florida Power & Light Company, Juno Beach, FL (US)

(72) Inventors: Charles Leitner, Boynton Beach, FL (US); Steven A. Greenstein, North Port, FL (US); Michael H. London, Delray Beach, FL (US)

(21) Appl. No.: 19/197,255

(22) Filed: May 2, 2025

(51) Int. Cl. H04B 3/54; H02J 1/08; H02J 7/35

(52) U.S. Cl. CPC H04B 3/548; H02J 1/084; H02J 7/35

(57) ABSTRACT

The disclosed technology relates generally to portable DC-powered telecommunications. The disclosed technology provides a power station configured to provide network connectivity to one or more devices. The power station includes a battery configured to store DC power. The power station includes a telecommunications device configured to receive DC power from at least one of an external power source and the battery. The telecommunications device can be configured to facilitate a wireless connection between the one or more devices and a network.

### FIELD OF TECHNOLOGY

The disclosed technology relates generally to portable power stations, and, more particularly, to systems for providing network connectivity to sites lacking network infrastructure.

### BACKGROUND

Power stations can be deployed to provide network connectivity to areas lacking network infrastructure. For example, power stations can be deployed to an area in response to emergencies, such as inclement weather and natural disasters, that impact not only the power grid in the area but also the telecommunications network. A key component of emergency response is restoring network connectivity in the impacted area.

Traditional power stations include equipment and devices operating using alternating current (AC) power. Accordingly, some traditional power stations employ inverters to convert direct current (DC) power to AC power usable by the equipment. These inverters require a significant load to operate, and can therefore significantly limit the available uptime of traditional power stations to operate independently of an external power source.

What is needed, therefore, is a novel system for providing portable DC-powered telecommunications. These and other advantages of the presently-disclosed technology will become apparent throughout the following disclosure.

### BRIEF SUMMARY

To achieve the above-described system for providing portable DC-powered telecommunications, the, the disclosed technology includes a power station configured to provide network connectivity to one or more devices. The power station can be configured to receive DC power from an external source. The power station can include a battery configured to store DC power from the external source. The power station can include a telecommunications device. The telecommunications device can be configured to receive DC power from at least one of the external power source and the battery. The telecommunications device can be configured to facilitate a wireless connection between the one or more devices and a network. The power station can be not configured to convert DC power to AC power.

According to another aspect of the present disclosure, the disclosed technology includes a method for providing network connectivity to a site lacking network infrastructure. The method can include providing a power station including a battery and a telecommunications device. The method can include charging the battery via DC power from an external power source without converting DC power to AC power. The method can include installing the power station at the site. The method can include powering the telecommunications device via DC power from at least one of the battery and the external power source.

According to another aspect of the present disclosure, the disclosed technology includes a system for providing network connectivity to a site lacking network infrastructure. The system can include a solar panel configured to generate DC power. The system can include a power station. The power station can include a first electrical coupling configured to facilitate electrical connection with the solar panel. The power station can include a second electrical coupling configured to facilitate electrical connection with an offsite power source configured to generate DC power. The power station can include a battery configured to receive DC power. The battery can be configured to receive DC power from the solar panel and DC power from the offsite power source. The power station can include a telecommunications device. The telecommunications device can be electrically connected to the battery and configured to facilitate a wireless connection between one or more devices and a network.

### BRIEF DESCRIPTION OF THE DRAWINGS

The accompanying drawings, which are incorporated in and constitute a part of this specification, illustrate various aspects of the presently disclosed subject matter and serve to explain the principles of the presently disclosed subject matter. The drawings are not intended to limit the scope of the presently disclosed subject matter in any manner.

FIG. 1 illustrates a diagram of a power station for providing portable DC-powered telecommunications, in accordance with examples of the present disclosure.

FIG. 2 illustrates a system for providing portable DC-powered telecommunications, in accordance with examples of the present disclosure.

FIG. 3 illustrates a block diagram of a system for providing portable DC-powered telecommunications, in accordance with examples of the present disclosure.

FIG. 4 illustrates a wiring diagram of a system for providing portable DC-powered telecommunications, in accordance with examples of the present disclosure.

FIGS. 5A-5C illustrate a method for providing portable DC-powered telecommunications, in accordance with examples of the present disclosure.

FIG. 6 is a flow diagram illustrating a method for providing portable DC-powered telecommunications, in accordance with examples of the present disclosure.

### DETAILED DESCRIPTION

To address the previously discussed challenges, there is a growing need for innovative solutions that provide portable, stand-alone, DC-powered telecommunications. One such solution involves a power station able to power its internal electrical components using DC power. The power station can be deployed for disaster-relief to bring network connectivity to an affected area. By utilizing DC power, the power station can be enabled with extended battery life, as well as “always-on” functionality to bring an affected area back online as quickly and efficiently as possible. Unlike existing systems that operate using AC powered telecommunications equipment, the disclosed technology can operate using DC power provided by an external power source.

The disclosed technology provides a portable, stand-alone solution for providing telecommunication ability, or network connectivity, to an area. As will be appreciated, there may exist areas of the world lacking in network infrastructure, in that the network infrastructure may have never existed, or that the previous infrastructure of the area was affected by a natural disaster or other large-scale event. In particular, it is imperative to bring network connectivity back to an impacted area to aid in disaster relief efforts. Impacted areas can also include an impacted power distribution system or power grid, making the powering of telecommunications equipment difficult. In this way, providing a solution to bringing network connectivity to an impacted area that can operate for an extended period of time is integral to the purpose of such a power station.

The disclosed technology can include a power station able to connect one or more devices to the internet when installed in an area lacking network infrastructure and potentially power. The power station can include a cabinet to secure electrical equipment and protect said equipment from external conditions (e.g., rain, wind, etc.). Among other equipment, the power station can include at least a battery for storing power and a telecommunications equipment for providing network connectivity. The power station can further include one or more electrical coupling points (e.g., receiving ends for electrical connections) configured to facilitate a transfer of electric power from a source to the battery and the telecommunications equipment. In some cases, a solar panel can be mounted onto the cabinet of the power station and electrically connected to the battery and the telecommunications equipment, allowing the solar panel to charge the battery and directly power the equipment. As can be appreciated, however, the power generated from a solar panel may vary based on a number of conditions of the weather and/or the panel. Thus, the battery can be charged at an offsite location prior to deployment to ensure the power station is deployed with substantial power. In this way, the power station can include electrical coupling for receiving power from an offsite DC charger and for facilitating the electrical connection with the solar panel. Without the need for an inverter, not only does the power station require less volume for electrical equipment, but also less load for powering the telecommunications equipment. Consequently, the power station can be switched on prior to installation to ensure that the installation site can have network access as soon as the power station is deployed.

The disclosed technology can be further understood according to the following non-limiting example. As can be appreciated, to fully and effectively bring online a network infrastructure for an area (e.g., during disaster recovery), it is beneficial to have a considerable battery life for a power station, and its telecommunications device/equipment, to operate independently of a grid-provided power source. In the non-limiting example, the installation site for the power station can include an area lacking network infrastructure and power. Telecommunications equipment can typically range between 48 V to 12 V rating that draws around 250 W/h based on the hardware being used. Typical portable power stations can average between 1000 W and 2000 W of power. Consequently, the telecommunications equipment necessary to bring the area of the installation site back online would only have enough power from traditional power stations to last for around 3-6 hours. In this way, the disclosed technology presents an improvement over current power stations. The extended battery life of the power station of the disclosed technology due, at least in part, to the lack of power inversion and corresponding cooling element load allows some examples of the disclosed technology to operate for over four days. At least this feature, along with other features presented herein, provide a significant improvement over current power stations of the art.

Although various aspects of the disclosed technology are explained in detail herein, it is to be understood that other aspects of the disclosed technology are contemplated. Accordingly, it is not intended that the disclosed technology is limited in its scope to the details of construction and arrangement of components expressly set forth in the following description or illustrated in the drawings. The disclosed technology can be implemented and practiced or carried out in various ways. In particular, the presently disclosed subject matter is described in the context of systems for providing DC-powered telecommunications. The present disclosure, however, is not so limited, and can be applicable in other contexts such as systems used for providing DC-powered telecommunications for other purposes such as academic and industrial purposes. Accordingly, when the present disclosure is described in the context of systems for providing DC-powered telecommunications, it will be understood that other implementations can take the place of those referred to herein.

It should also be noted that, as used in the specification and the appended claims, the singular forms “a,” “an,” and “the” include plural references unless the context clearly dictates otherwise. References to a composition containing “a” constituent is intended to include other constituents in addition to the one named.

Also, in describing the disclosed technology, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, the disclosed technology can include from the one particular value and/or to the other particular value. Further, ranges described as being between a first value and a second value are inclusive of the first and second values. Likewise, ranges described as being from a first value and to a second value are inclusive of the first and second values.

Herein, the use of terms such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

The components described hereinafter as making up various elements of the disclosed technology are intended to be illustrative and not restrictive. Many suitable components that would perform the same or similar functions as the components described herein are intended to be embraced within the scope of the disclosed technology. Such other components not described herein can include, but are not limited to, similar components that are developed after development of the presently disclosed subject matter.

Referring now to the drawings, in which like numerals represent like elements, the present disclosure is herein described.

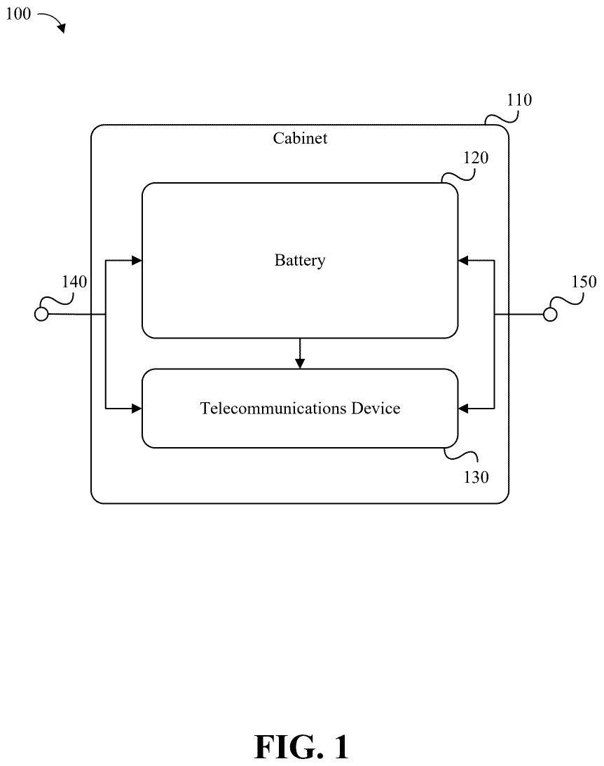

FIG. 1 illustrates a power station 100 configured to provide network connectivity to one or more devices. The power station 100 can include a cabinet 110 configured to store components of the power station 100. The cabinet 110 can be characterized as an enclosure for housing equipment of the power station 100. Some equipment can be disposed within the cabinet 110 (or enclosure), and some equipment can be attached to an exterior of the cabinet 110. The cabinet 110 can be configured to protect components housed within the cabinet 110 from inclement weather conditions, such as rain, wind, dust, etc. That is, in some embodiments, the cabinet 110 can include a substantially metal enclosure with doors for accessing equipment disposed within the cabinet 110. In other embodiments, the cabinet 110 can be substantially non-metal.

The power station 100 can include a battery 120. The battery 120 can be housed within the cabinet 110. That is, the battery 120 can be disposed within an interior of the cabinet 110. The battery 120, as can be understood by those skilled in the art, can be configured to receive, store, and discharge power. In some embodiments, the battery 120 can be charged and discharged based on the energy needs of the power station 100. As will be discussed in greater detail herein, the battery 120 can be configured to receive DC power from one or more external sources and discharge DC power to one or more devices of the power station 100.

The power station 100 can include a telecommunications device 130 configured to facilitate network connectivity for one or more devices. As can be appreciated, the telecommunications device 130 can be housed within the cabinet 110. Stated otherwise, the telecommunications device 130 can be configured to be disposed within the interior of the cabinet 110, so as to protect the telecommunications device 130 from inclement weather conditions. The telecommunications device 130 can include any device, system, or the like configured to facilitate a network connection between a network and a device. As will be discussed in greater detail herein, the telecommunications device 130 can include a satellite uplink, a router, a modem, a switch, an access point, etc. As will be appreciated, the telecommunications device 130 can be part of a telecommunications system of the power station including one or more telecommunications devices to facilitate network connection.

The power station 100 can include a first electrical coupling 140 configured to facilitate an electrical connection between an external power source and the power station 100. In some embodiments, the first electrical coupling 140 can be electrically connected to the battery 120, such that the battery 120 can be configured to receive power from an external power source via the first electrical coupling 140. In some embodiments, the first electrical coupling 140 can be electrically connected to the telecommunications device 130, such that the telecommunications device 130 can be configured to receive power from an external power source via the first electrical coupling 140. In some embodiments, the first electrical coupling 140 can be electrically connected to the battery 120 and the telecommunications device 130, such that the power station 100 can receive power from an external power source via the first electrical coupling 140, and the power can be used to charge the battery 120 and directly power the telecommunications device 130.

The power station 100 can include a second electrical coupling 150 configured to facilitate an electrical connection between an external power source and the power station 100. In some embodiments, the second electrical coupling 150 can be electrically connected to the battery 120, such that the battery 120 can be configured to receive power from an external power source via the second electrical coupling 150. In some embodiments, the second electrical coupling 150 can be electrically connected to the telecommunications device 130, such that the telecommunications device 130 can be configured to receive power from an external power source via the second electrical coupling 150. In some embodiments, the second electrical coupling 150 can be electrically connected to the battery 120 and the telecommunications device 130, such that the power station 100 can receive power from an external power source via the second electrical coupling 150, and the power can be used to charge the battery 120 and directly power the telecommunications device 130.

As will be appreciated, the first electrical coupling 140 and the second electrical coupling 150 can be configured to receive DC power from external power sources. That is, the first electrical coupling 140 can be configured to facilitate an electrical connection between the power station 100 and a first DC power source, and the second electrical coupling 150 can be configured to facilitate an electrical connection between the power station 100 and a second DC power source.

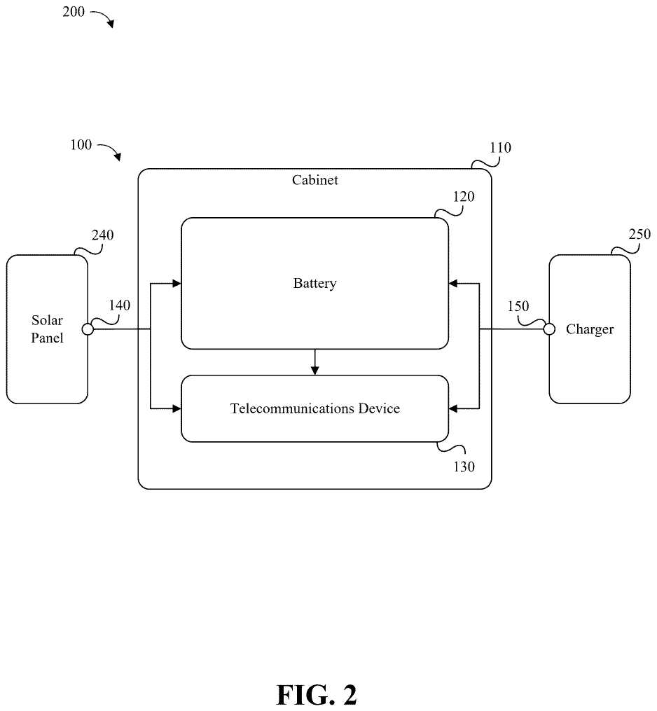

FIG. 2 illustrates a system 200 including the power station 100, a solar panel 240, and a charger 250. As shown, the solar panel 240 can be electrically connected to the power station 100 via the first electrical coupling 140. In this way, the solar panel 240 can be configured to provide power to the power station 100 via the first electrical coupling 140. As understood by those skilled in the art, the solar panel 240 can be configured to generate solar power in the form of DC power. That is, the DC power generated by the solar panel 240 can be used to charge the battery 120 and/or directly power the telecommunications device 130. In some embodiments, the solar panel 240 can be affixed to the exterior of the cabinet 110, such that the solar panel 240 can be transported with the power station 100. In this way, the solar panel 240 can continuously charge the battery 120 and power the telecommunications device 130 during transportation of the power station 100, installation of the power station 100, and after installation of the power station 100. In other words, the power station 100 can be installed with the solar panel 240 attached, allowing the solar panel 240 to serve as an external power source for the power station 100 when installed. As can be appreciated, the solar panel 240 can be part of a plurality of solar panels configured to be attached, coupled, or otherwise affixed to the exterior of the cabinet 110 of the power station 100.

In some embodiments, the battery 120 and the telecommunications device 130 can be configured to operate using DC power. That is, the battery 120 can be configured to receive, store, and discharge DC power generated by the solar panel 240, and the telecommunications device 130 can be powered by DC power generated by the solar panel 240 and/or discharged by the battery 120. In this way, the DC power can be un-inverted power, such that the power station 100, in some embodiments, can be not configured to convert the DC power to AC power. By powering the components (e.g., the battery 120 and the telecommunications device 130) of the power station 100 via DC power, the power station 100 can operate as a stand-alone entity without the need for a nearby charger (e.g., the charger 250), and avoid the loss of electric power present in traditional power stations to inversion of the DC power to AC power. Stated otherwise, the battery 120 and the telecommunications device 130 can operate without the need for cooling elements present in traditional power stations, eliminating a secondary need for power.

As shown, the charger 250 can be electrically connected to the power station 100 via the second electrical coupling 150. In this way, the charger 250 can be configured to charge the battery 120 and/or directly power the telecommunications device 130 via the second electrical coupling 150. As will be appreciated, the charger 250 can include any system configured to generate DC power. In some embodiments, the charger 250 can be a charging point of the electric grid, a charging point of a local grid/microgrid, a grid charger, a battery bank, a generator, a DC charging station, or similar systems understood for similar contexts in the art. As can be appreciated, the charger 250 may not be portable, in that use of the charger 250 as an external power source for the power station 100 can be dependent on the presence of the charger 250 near the power station 100. In this way, the charger 250 can be optional, such that the power station 100 can be powered solely via the solar panel 240. As will be discussed in greater detail herein, the charger 250, and similarly the second electrical coupling 150, can be used to charge the battery 120 prior to transporting the power station to the installation site. That is, the charger 250 can be located at an offsite location, or in other words, be an offsite power source. In some cases, a charger (e.g., the charger 250), can be present at the installation site and used to power the power station 100. However, in the event that the installation site lacks a charger of similar contexts to the charger 250, the power station 100 can be deployed/installed while powering the telecommunications device 130 via the battery 120 (that can have been charged by the charger 250 prior to transportation to the installation site) and the solar panel 240 (that can be affixed to the exterior of the cabinet 110 of the power station 100). In this way, the system 200 can be representative of the power station 100 pre-installation, in that the power station 100 can be electrically connected to the charger 250 to charge the battery 120 before transporting the power station 100 to the installation site.

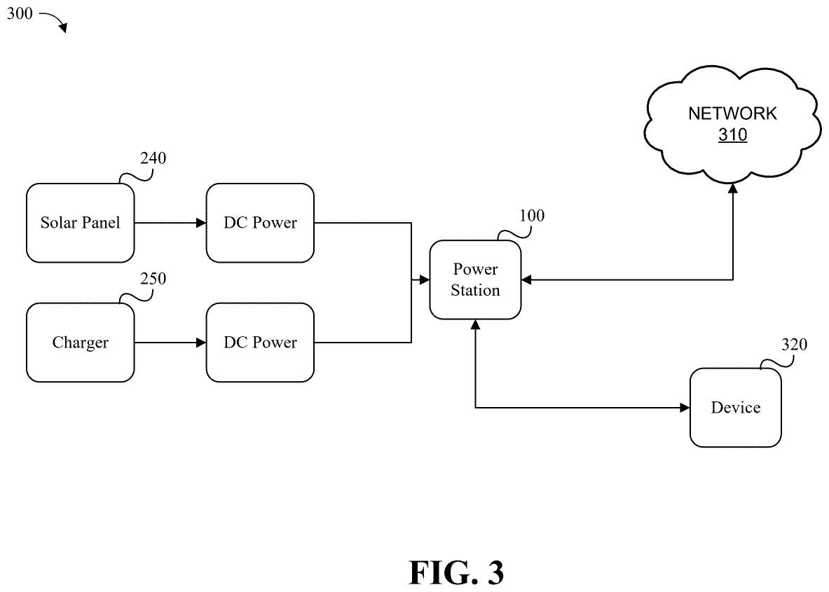

FIG. 3 illustrates a block diagram of a system 300 for providing DC-powered telecommunications. As discussed herein, the power station 100 can be electrically connected to the solar panel 240, such that the solar panel 240 can provide DC power to the power station 100. In some embodiments, the power station 100 can be electrically connected to the charger 250, such that the charger 250 can provide DC power to the power station 100. The power station 100 can facilitate a network connection between a network 310 and a device 320. The network 310 can include a satellite network, an RF network, a cellular network, or similar networks understood in the art. The device 320 can include a mobile device, a laptop, a desktop computer, or any similar computing devices understood in the art. As will be discussed in greater detail herein, the power station 100 can facilitate the network connection between the network 310 and the device 320 via the telecommunications device 130. In this way, the power station 100 can provide network connectivity to the device 320 via DC power without the need to invert the DC power to AC power.

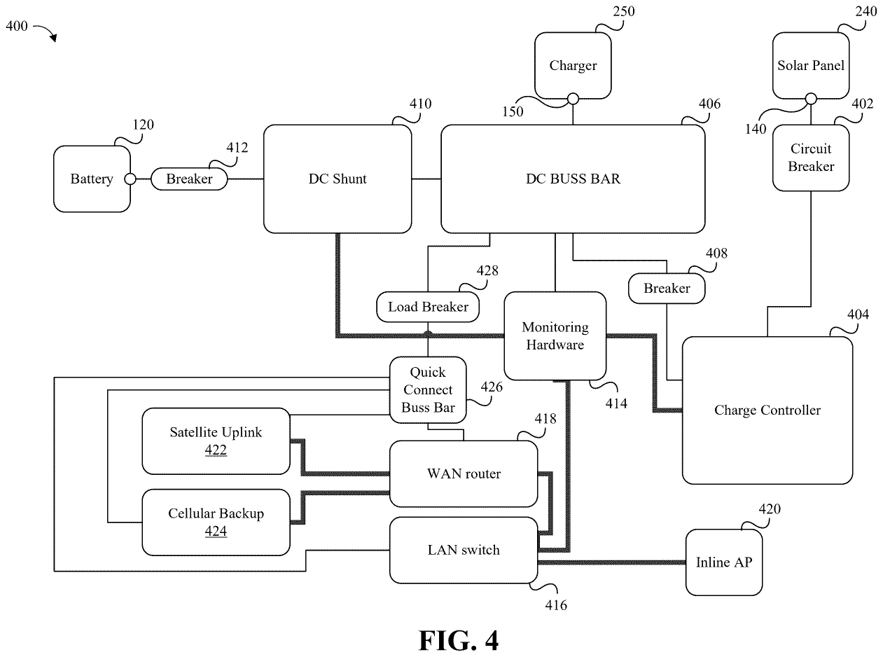

FIG. 4 illustrates a wiring diagram for a system 400 for providing portable DC-powered telecommunications. As a non-limiting example, the thin-line connections can represent electrical connections (e.g., a conduit or a cable) for transferring power, and the thick-line connections can represent network connections (e.g., an ethernet cable) for transferring network signals.

The solar panel 240, when connected to the first electrical coupling 140, can be further electrically connected to a circuit breaker 402. As shown, the circuit breaker 402 can be electrically connected to a charge controller 404 configured to regulate voltage and current of power received from the solar panel 240. For example, the charge controller 404 can include a maximum power point tracking (MPPT) charge controller configured to optimize power output by adjusting an electrical operating point of the system 400. The charge controller 404, as understood in the art, can be configured to prevent overcharging and over-discharging of the system 400. The charge controller 404 can be electrically connected to a DC buss bar 406 via a breaker 408. The DC buss bar 406 can be configured to conduct electric power and distribute electric power throughout the system 400. As shown, the charger 250, when connected to the second electric coupling 150, can be electrically connected to the DC buss bar 406. As will be discussed in greater detail herein, the DC buss bar 406 can be configured to receive DC power from the solar panel 240 and the charger 250 and distribute DC power to other components of the system 400.

In some embodiments, the DC buss bar 406 can be electrically connected to the battery 120 via a DC shunt 410 and a breaker 412. The DC shunt 410 can be configured to regulate voltage and measure current travelling between the battery 120 and the DC buss bar 406. That is, the DC shunt 410 can be configured to regulate voltage of DC power being transferred to the battery 120 and DC power being discharged by the battery 120.

The DC buss bar 406 can be further electrically connected to monitoring hardware 414 configured to monitor components of the system 400. For example, the monitoring hardware 414 can be electrically connected to the charge controller 404 and the DC shunt 410 to monitor power characteristics of the charge controller 404 and the DC shunt 410, respectively. In some embodiments, the electrical connection between the monitoring hardware 414 and the charge controller 404 can be a signal cable configured to transfer information in the form of a signal between the monitoring hardware and the charge controller 404. A similar connection can be present between the monitoring hardware 414 and the DC shunt 410, as shown. The signal cable, as can be understood by one of skill in the art, can include an ethernet cable, a USB cable, a USB-C cable, or the like. In this way, the monitoring hardware 414 can be configured to communicate power characteristics of the charge controller 404 and the DC shunt 410 in the form of a signal to one or more components of the system 400.

The monitoring hardware 414 can be electrically connected to a LAN switch 416. The LAN switch 416 can be further electrically connected to a WAN router 418 and a wireless access point, such as an inline AP 420. The WAN router 418 can be further electrically connected to a satellite uplink 422 configured to communicate with a satellite network. In some embodiments, the WAN router 418 can be further electrically connected to a cellular backup 424 configured to communicate with a cellular network. In some embodiments, the cellular backup 424 can include a cellular radio. As shown, the electrical connection between the monitoring hardware 414 and the LAN switch 416, the LAN switch 416 and the WAN router 418, the LAN switch 416 and the inline AP 420, the WAN router 418 and the satellite uplink 422, and the WAN router 418 and the cellular backup 424 can include any embodiments of the signal cable discussed herein configured to transmit information in the form of an electric signal.

The LAN switch 416, the WAN router 418, the inline AP 420, the satellite uplink 422, and the cellular backup 424 can operate in conjunction to provide DC-powered telecommunications. For example, the inline AP 420 can provide wireless connectivity to a device, such as the device 320. The satellite uplink 422 can wirelessly communicate with a satellite network to provide network connectivity, which can be communicated to the inline AP 420 via the WAN router 418 and the LAN switch 416. In some embodiments, the satellite uplink 422 can serve as a primary network device, such that the cellular backup 424 can be configured to provide network connectivity via a cellular network in the event of a loss of connection to the satellite network, a failure of the satellite uplink, or the like.

In some embodiments, the LAN switch 416, the WAN router 418, the satellite uplink 422, and the cellular backup 424 can be electrically connected to a quick connect buss bar 426. The quick connect buss bar 426 can be further electrically connected to the DC buss bar 406 via a load breaker 428. In this way, DC power can be distributed by the DC buss bar 406 and the quick connect buss bar 426 to the LAN switch 416, the WAN router 418, the satellite uplink 422, and the cellular backup 424. For example, the solar panel 240 can power any combination of the LAN switch 416, the WAN router 418, the satellite uplink 422, and the cellular backup 424 by transmitting the DC power to the quick connect buss bar 426 via the charge controller 404 and the DC buss bar 406. Similarly, the charger 250 can power any combination of the LAN switch 416, the WAN router 418, the satellite uplink 422, and the cellular backup 424 by transmitting DC power to the quick connect buss bar 426 via the DC buss bar 406. In some embodiments, the battery 120 can power any combination of the LAN switch 416, the WAN router 418, the satellite uplink 422, and the cellular backup 424 by discharging DC power to the quick connect buss bar 426 via the DC buss bar 406 and the DC shunt 410. In some embodiments, the battery 120 can receive DC power via the charger 250 via the DC buss bar 406 and the DC shunt 410. Similarly, the battery 120 can receive DC power from the solar panel 240 via the charge controller 404, the DC buss bar 406, and the DC shunt 410. Accordingly, in some embodiments, the LAN switch 416, the WAN router 418, the satellite uplink 422, and the cellular backup 424 can be powered via DC power discharged from the battery 120 supplied via one of the solar panel 240 and the charger 250.

In some embodiments, the telecommunications device 130 can include the satellite uplink 422. In some embodiments, the telecommunications device 130 can further include the cellular backup 424. In some embodiments, the telecommunications device 130 can further include the WAN router 418. In some embodiments, the telecommunications device 130 can further include the LAN switch 416. In some embodiments, the telecommunications device 130 can further include the inline AP 420. In some embodiments, the telecommunications device 130 can include the satellite uplink 422, the cellular backup 424, and some combination of the WAN router 418, the LAN switch 416, and the inline AP 420. In some embodiments, the telecommunications device 130 can include the LAN switch 416, the WAN router 418, the satellite uplink 422, and the cellular backup 424. In this way, the telecommunications device 130 can be configured to provide DC-powered network connectivity. Accordingly, the telecommunications device 130 can be configured to provide network connectivity to at least a first network (e.g., the satellite network) and a second network (e.g., the cellular network).

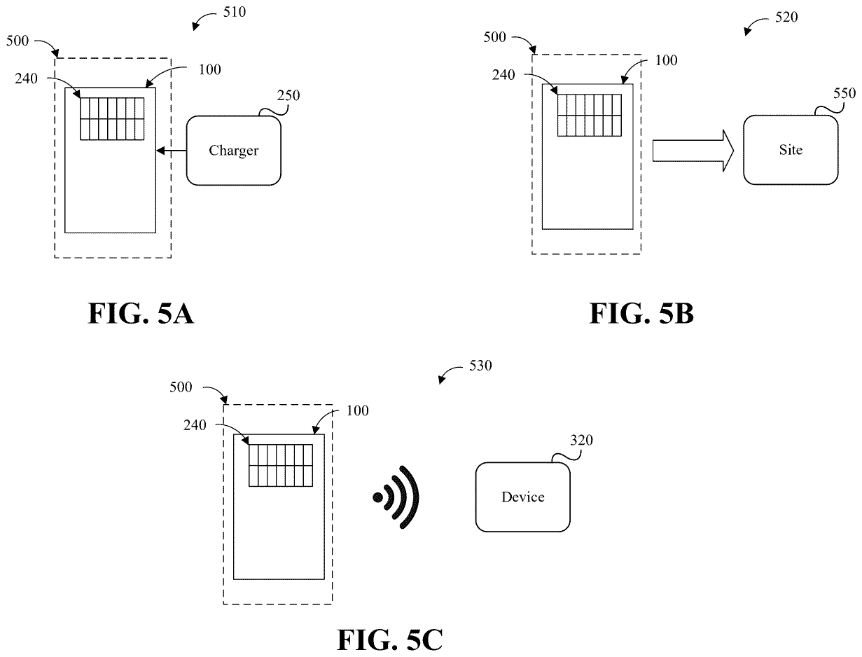

FIGS. 5A-5C illustrate an example method for providing portable DC-powered telecommunications by deploying a system 500 at a site 550. As can be appreciated, the site 550 can include any embodiments of the installation site and sites discussed herein, in that the site 550 can be an installation site for the system 500. In some cases, the site 550 can include, or be part of, an area lacking network infrastructure and potentially power, as discussed for examples herein.

The system 500 can include the power station 100 and the solar panel 240. As discussed herein, the solar panel 240 can be mounted, or otherwise affixed, to the exterior of the cabinet 110 of the power station 100, such that the solar panel 240 and the power station 100 can be transported and installed together. In this way, the system 500 can operate as a stand-alone portable DC-powered telecommunications solution, in that the system 500 (and the components of the power station 100 discussed herein) can be configured to be powered solely via the solar panel 240.

As shown in FIG. 5A, a step 510 of the method can include the system 500 receiving power from the charger 250. As discussed, the system 500 can include the power station 100 and the solar panel 240. The charger 250 can be electrically connected to the power station 100 so as to allow a transfer of DC power from the charger 250 to the power station 100, as discussed herein. In some embodiments, the step 510 can include charging the battery 120 of the power station 100. As can be appreciated, the step 510 can be pre-installation. In some embodiments, the step 510 can be performed pre-transportation of the system 500 to the site 550. In this way, the system 500 (and the battery 120) can be charged at a facility, plant, or a location of similar context, prior to being deployed to the site 550.

As shown in FIG. 5B, a step 520 of the method can include the system 500 being transported to the site 550. As discussed, the system 500 can include the power station 100 and the solar panel 240. As can be appreciated, the site 550 can include an area lacking network infrastructure and/or a DC power source capable of powering the system 500. For example, the site 550 can include an area affected by natural disaster where the electric grid has been impacted, impacting the distribution of electric power and potentially the network connectivity in the area. Accordingly, the step 510 can be completed off-site, to charge the system 500 prior to deployment to the site 550, such that the method can include the step 520 of transporting the system 500 to the site 550.

The system 500, as discussed for the power station 100, can have an on-configuration and an off-configuration. As can be appreciated, the system 500 can be actively providing network connectivity in the on-configuration, such that the system 500 can be drawing, or using, electric power in the on-configuration. In some embodiments, the system 500 can be switched to the on-configuration after charging in the step 510 and before transportation in the step 520. In this way, the system 500 can be an “always-on” solution, in that the system 500 can be configured to immediately provide network connectivity to devices of the site 550 upon installation. As can be appreciated, the system 500 can be configured to be “always-on” based at least in part on the system 500 being DC-powered, in that the powering of the components of the power station 100 not requiring inversion of the DC generated power to AC power can prolong the battery-life of the power station 100. Additionally, the solar panel 240 can provide continuous power to charge the battery 120 and/or power the telecommunications device 130 as the initially charged battery 120 is depleted over time.

As shown in FIG. 5C, a step 530 of the method can include the system 500 providing network connectivity to the device 320. As discussed, the system 500 can include the power station 100 and the solar panel 240. As can be appreciated, the step 530 can further include installing the system 500 at the site 550. In some embodiments, the system 500 can be in the on-configuration during installation, allowing the system 500 to provide network connectivity to the device 320 immediately upon deployment. In this way, the system 500 can be an effective solution for disaster relief, and avoid hinderance of delays due to difficulty in installation or the like. The system 500 can provide network connectivity to the device 320 according to embodiments of the telecommunications device 130 discussed herein. That is, in some cases, the step 530 can include providing telecommunications via a satellite network and optionally a cellular network.

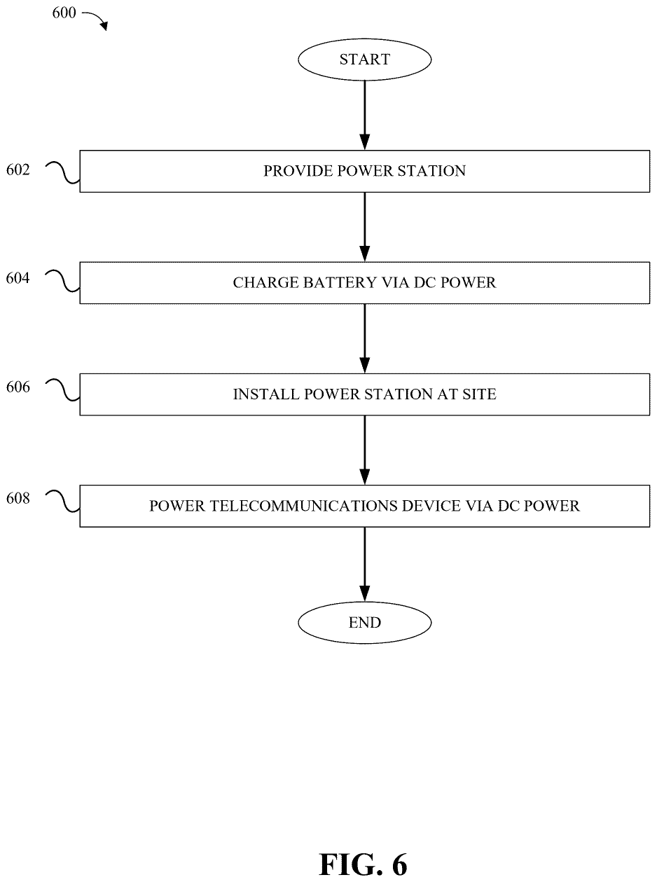

FIG. 6 illustrates a method 600 for providing portable DC-powered telecommunications. The method 600 can include providing 602 a power station. The power station can include any embodiments of the power station 100 discussed herein. In some embodiments, the power station can include a cabinet (e.g., the cabinet 110) including an enclosure for housing telecommunications equipment. The power station can further include at least a battery and a telecommunications device. The battery can include any embodiments of the battery 120 discussed herein, and the telecommunications device can include any embodiments of the telecommunications device 130 discussed herein. For example, the power station can include a circuit breaker (e.g., the circuit breaker 402), a charge controller (e.g., the charge controller 404), one or more breakers (e.g., the breaker 408 and the breaker 412), a DC buss bar (e.g., the DC buss bar 406), a DC shunt (e.g., the DC shunt 410), monitoring hardware (e.g., the monitoring hardware 414), a LAN switch (e.g., the LAN switch 416), a WAN router (e.g., the WAN router 418), an inline AP (e.g., the inline AP 420), a satellite uplink (e.g., the satellite uplink 422), a cellular backup (e.g., the cellular backup 424), a quick connect buss bar (e.g., the quick connect buss bar 426), and a load breaker (e.g., the load breaker 428). These components can be disposed within the cabinet of the power station. In some embodiments, the components of the power station can be wired according to the wiring diagram of FIG. 4. The power station can include a first electrical coupling (e.g., the first electrical coupling 140) and a second electrical coupling (e.g., the second electrical coupling 150). In some embodiments, the power station can be not configured to convert the DC power to AC power. In this way, the power station can power the telecommunications device solely via DC power without the need to convert the DC power to AC power.

The method 600 can include charging 604 the battery via DC power. In some embodiments, the DC power can be provided from an external power source. For example, the battery can be charged via DC power generated by a solar panel (e.g., the solar panel 240). Stated otherwise, the external power source can include the solar panel. In other embodiments, the battery can be charged via DC power from a charger (e.g., the charger 250), in that the external power source can include the charger. As discussed herein, the solar panel can be mounted, attached, or otherwise affixed to an exterior of the cabinet of the power station, such that the solar panel can be transported with the power station. In some embodiments, the battery can be charged via the charger prior to installation of the power station. In some embodiments, the battery can be charged via the charger prior to transportation of the power station (and optionally the solar panel) to the site (e.g., the site 550). In some embodiments, the battery can be charged via the solar panel prior to installation, prior to transportation, during transportation, during installation, and/or post-installation, as will be appreciated.

The method 600 can include installing 606 the power station at the site. The site can include any embodiments of the site 550 discussed herein. That is, the site can include an area lacking network infrastructure, lacking telecommunication ability, lacking network connectivity, or having a power distribution being affected. For example, the site can include an area affected by a natural disaster or similar event where the electric grid and/or telecommunications of the area have been affected. Installing 606 the power station at the site can include transporting the power station to the site. In some embodiments, the power station can be transported from an offsite location to the site. In some cases, the power station can be switched to the on-configuration prior to or during transportation, enabling the “always-on” functionality discussed herein. In other embodiments, installing 606 the power station at the site can include switching the power station to the on-configuration.

The method 600 can include powering 608 the telecommunications device via DC power. As can be appreciated, the DC power can be from at least one of the battery and the solar panel. Accordingly, the first electrical coupling can facilitate powering of the telecommunications device via the solar panel. In some embodiments, the telecommunications device can be powered according to the wiring diagram illustrated in FIG. 4. Powering 608 the telecommunications device can cause the telecommunications device to provide network connectivity to a device (e.g., the device 320). That is, the telecommunications device being powered can cause the telecommunications device to communicate with a network (e.g., the satellite network and the cellular network) to provide a wireless access point for the device to connect to the network. For example, the telecommunications device can be configured to transmit and receive wireless communications to facilitate network connectivity for the device.

The disclosed technology can be further understood according to the following clauses:
Clause 1: A power station configured to receive direct current (DC) power from an external power source and provide network connectivity to one or more devices, comprising: a battery configured to store DC power from the external power source; and a telecommunications device configured to: receive DC power from at least one of the external power source and the battery, wherein the power station is not configured to convert DC power to alternating current (AC) power; and facilitate a wireless connection between the one or more devices and a network.
Clause 2: The power station of Clause 1, wherein the external power source comprises a solar panel, the power station further comprising an electrical coupling to electrically connect the solar panel to the battery, the battery being configured to receive DC power in the form of solar power from the solar panel via the electrical coupling.
Clause 3: The power station of Clause 2, wherein the external power source is a first external power source, the power station being further configured to receive DC power from a second external power source being selected from a group consisting of: a battery bank, a grid charger, a DC charging station, and a DC microgrid.
Clause 4: The power station of Clause 3, wherein the electrical coupling is a first electrical coupling, the power station further comprising a second electrical coupling to electrically connect the second external power source to the battery, the battery being configured to receive DC power from the second external power source via the second electrical coupling.
Clause 5: The power station of Clause 1, wherein the telecommunications device comprises a satellite uplink configured to be powered via DC power.
Clause 6: The power station of Clause 1, wherein the network comprises at least one of a satellite network and a cellular network.
Clause 7: A method for providing network connectivity to a site lacking network infrastructure, comprising: providing a power station comprising a battery and a telecommunications device; charging the battery via direct current (DC) power from an external power source without converting DC power to alternating current (AC) power; installing the power station at the site; and powering the telecommunications device via DC power from at least one of the battery and the external power source.
Clause 8: The method of Clause 7, wherein the external power source comprises a solar panel configured to generate DC power.
Clause 9: The method of Clause 8, wherein the power station comprises a cabinet housing the battery and the telecommunications device, the solar panel mounted to an exterior of the cabinet.
Clause 10: The method of Clause 9, further comprising charging the battery via the solar panel while the power station is installed.
Clause 11: The method of Clause 7, further comprising facilitating wireless connection between one or more devices and a network via the telecommunications device.
Clause 12: The method of Clause 11, wherein the network is provided via a satellite uplink.
Clause 13: The method of Clause 11, wherein the network comprises a cellular network.
Clause 14: The method of Clause 7, wherein charging the battery via DC power from the external power source without converting DC power to AC power comprises: charging the battery at an offsite location; and switching the power station to an on-configuration at the offsite location.
Clause 15: The method of Clause 14, further comprising transporting the power station from the offsite location to the site, wherein the power station is continuously in the on-configuration during transportation.
Clause 16: A system for providing network connectivity to a site lacking network infrastructure, comprising: a solar panel configured to generate direct current (DC) power; and a power station comprising: a first electrical coupling configured to facilitate a first electrical connection with the solar panel; a second electrical coupling configured to facilitate a second electrical connection with an offsite power source configured to generate DC power; a battery configured to receive DC power from the solar panel and DC power from the offsite power source; and a telecommunications device electrically connected to the battery and configured to facilitate a wireless connection between one or more devices and a network.
Clause 17: The system of Clause 16, wherein the first electrical coupling is further configured to facilitate the first electrical connection between the solar panel and the telecommunications device, such that the telecommunications device can be powered via at least one of the battery and the solar panel.
Clause 18: The system of Clause 16, wherein the telecommunications device comprises a satellite uplink configured to facilitate network connectivity with a satellite network.
Clause 19: The system of Clause 16, wherein the power station comprises an off-configuration and an on-configuration, wherein the power station is configured to be in the on-configuration during transportation from an offsite location to an installation site, during installation of the power station at the installation site, and after installation of the power station at the installation site.
Clause 20: The system of Clause 19, wherein the telecommunications device is configured to receive DC power from at least one of the battery and the solar panel after installation of the power station at the installation site.

While the present disclosure has been described in connection with a plurality of exemplary aspects, as illustrated in the various figures and discussed above, it is understood that other similar aspects can be used, or modifications and additions can be made to the described subject matter for performing the same function of the present disclosure without deviating therefrom. In this disclosure, systems and compositions were described according to aspects of the presently disclosed subject matter. But other equivalent systems or compositions to these described aspects are also contemplated by the teachings herein. Therefore, the present disclosure should not be limited to any single aspect, but rather construed in breadth and scope in accordance with the appended claims.

What is claimed is:

1. A power station configured to receive direct current (DC) power from an external power source and provide network connectivity to one or more devices, comprising:
a battery configured to store DC power from the external power source; and
a telecommunications device configured to:
receive DC power from at least one of the external power source and the battery, wherein the power station is not configured to convert DC power to alternating current (AC) power; and
facilitate a wireless connection between the one or more devices and a network.

2. The power station of claim 1, wherein the external power source comprises a solar panel, the power station further comprising an electrical coupling to electrically connect the solar panel to the battery, the battery being configured to receive DC power in the form of solar power from the solar panel via the electrical coupling.

3. The power station of claim 2, wherein the external power source is a first external power source, the power station being further configured to receive DC power from a second external power source being selected from a group consisting of: a battery bank, a grid charger, a DC charging station, and a DC microgrid.

4. The power station of claim 3, wherein the electrical coupling is a first electrical coupling, the power station further comprising a second electrical coupling to electrically connect the second external power source to the battery, the battery being configured to receive DC power from the second external power source via the second electrical coupling.

5. The power station of claim 1, wherein the telecommunications device comprises a satellite uplink configured to be powered via DC power.

6. The power station of claim 1, wherein the network comprises at least one of a satellite network and a cellular network.

7. A method for providing network connectivity to a site lacking network infrastructure, comprising:
providing a power station comprising a battery and a telecommunications device;
charging the battery via direct current (DC) power from an external power source without converting DC power to alternating current (AC) power;
installing the power station at the site; and
powering the telecommunications device via DC power from at least one of the battery and the external power source.

8. The method of claim 7, wherein the external power source comprises a solar panel configured to generate DC power.

9. The method of claim 8, wherein the power station comprises a cabinet housing the battery and the telecommunications device, the solar panel mounted to an exterior of the cabinet.

10. The method of claim 9, further comprising charging the battery via the solar panel while the power station is installed.

11. The method of claim 7, further comprising facilitating wireless connection between one or more devices and a network via the telecommunications device.

12. The method of claim 11, wherein the network is provided via a satellite uplink.

13. The method of claim 11, wherein the network comprises a cellular network.

14. The method of claim 7, wherein charging the battery via DC power from the external power source without converting DC power to AC power comprises:
charging the battery at an offsite location; and
switching the power station to an on-configuration at the offsite location.

15. The method of claim 14, further comprising transporting the power station from the offsite location to the site, wherein the power station is continuously in the on-configuration during transportation.

16. A system for providing network connectivity to a site lacking network infrastructure, comprising:
a solar panel configured to generate direct current (DC) power; and
a power station comprising:
a first electrical coupling configured to facilitate a first electrical connection with the solar panel;
a second electrical coupling configured to facilitate a second electrical connection with an offsite power source configured to generate DC power;
a battery configured to receive the DC power from the solar panel and DC power from the offsite power source; and
a telecommunications device electrically connected to the battery and configured to facilitate a wireless connection between one or more devices and a network.

17. The system of claim 16, wherein the first electrical coupling is further configured to facilitate the first electrical connection between the solar panel and the telecommunications device, such that the telecommunications device can be powered via at least one of the battery and the solar panel.

18. The system of claim 16, wherein the telecommunications device comprises a satellite uplink configured to facilitate network connectivity with a satellite network.

19. The system of claim 16, wherein the power station comprises an off-configuration and an on-configuration, wherein the power station is configured to be in the on-configuration during transportation from an offsite location to an installation site, during installation of the power station at the installation site, and after installation of the power station at the installation site.

20. The system of claim 19, wherein the telecommunications device is configured to receive DC power from at least one of the battery and the solar panel after installation of the power station at the installation site.
